(19) United States
(12) Patent Application Publication
(10) Pub. No.: US 2026/0245560 A1
(43) Pub. Date: Aug. 20, 2026

(54) ELECTRONIC DEVICE AND METHOD FOR PROCESSING USER UTTERANCE

(71) Applicant: SAMSUNG ELECTRONICS CO., LTD., Suwon-si (KR)

(72) Inventors: Sangmin PARK, Suwon-si (KR); Gajin Song, Suwon-si (KR); Kyungtae Kim, Suwon-si (KR)

(73) Assignee: SAMSUNG ELECTRONICS CO., LTD., Suwon-si (KR)

(21) Appl. No.: 19/646,136

(22) Filed: Apr. 13, 2026

Related U.S. Application Data
(63) Continuation of application No. PCT/KR2024/096313, filed on Oct. 11, 2024.

(30) Foreign Application Priority Data
Oct. 13, 2023 (KR) 10-2023-0136987
Nov. 10, 2023 (KR) 10-2023-0155118

(51) Int. Cl. G10L 15/26; G10L 25/51

(52) U.S. Cl. CPC G10L 15/26; G10L 25/51

(57) ABSTRACT

An operation method of an electronic device includes: receiving a first input from a user; based on receiving the first input, creating a first session; providing a first output corresponding to the first input, based on a generative model; receiving a second input from the user; based on a condition between the first input and the second input and a condition between the first output and the second input being satisfied, creating a second session that is different from the first session; and providing a second output corresponding to the second input, based on the generative model.

### CROSS-REFERENCE TO RELATED APPLICATIONS

This application is a continuation of International Application No. PCT/KR2024/096313, filed on October 11, 2024, which is based on and claims priority to Korean Patent Application No. 10-2023-0136987, filed on October 13, 2023, and Korean Patent Application No. 10-2023-0155118, filed on November 10, 2023, in the Korean Intellectual Property Office, the disclosures of which are incorporated by reference herein in their entireties.

### BACKGROUND

### 1. FIELD

The present disclosure relates to an electronic device and a method of processing a user utterance.

### 2. DESCRIPTION OF RELATED ART

An electronic device including a voice assistant function that provides a service based on a user utterance has been widely distributed. The electronic device may recognize an utterance of a user using an artificial intelligence (AI) server and may identify the meaning and intent of the utterance. The AI server may interpret the utterance of the user to infer the intent of the user and may perform tasks according to the inferred intent. The AI server may perform a task according to the intent of the user expressed through natural language interactions between the user and the AI server.

An electronic device including a voice assistant function may perform, in a temporal sequence, an operation of classifying a domain for processing a user utterance and an operation of performing a task corresponding to the user utterance in the classified domain (e.g., a capsule) (e.g., an application).

The above information may be presented as the related art to assist with the understanding of the disclosure. No arguments or decisions are made as to whether any of the above is applicable as a prior art related to the disclosure.

### SUMMARY

According to an aspect of the disclosure, an operating method of an electronic device, includes: receiving a first input from a user; based on receiving the first input, creating a first session; providing a first output corresponding to the first input, based on a generative model; receiving a second input from the user; based on a condition between the first input and the second input and a condition between the first output and the second input being satisfied, creating a second session that is different from the first session; and providing a second output corresponding to the second input, based on the generative model.

According to an aspect of the disclosure, an electronic device includes: at least one processor; and memory storing instructions, wherein the instructions, when executed by the at least one processor individually or collectively, cause the electronic device to: receive a first input from a user; based on receiving the first input, create a first session; provide a first output corresponding to the first input, based on a generative model; receive a second input from the user; based on a condition between the first input and the second input and a condition between the first output and the second input being satisfied, create a second session that is different from the first session; and provide a second output corresponding to the second input, based on the generative model.

According to an aspect of the disclosure, a non-transitory computer-readable storage medium stores one or more programs, the one or more programs comprising instructions which, when executed by a processor of an electronic device, cause the electronic device to: receive a first input from a user; based on receiving the first input, create a first session; provide a first output corresponding to the first input, based on a generative model; receive a second input from the user; based on a condition between the first input and the second input and a condition between the first output and the second input being satisfied, create a second session that is different from the first session; and provide a second output corresponding to the second input, based on the generative model.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment, according to an embodiment;

FIG. 2 is a block diagram illustrating an integrated intelligence system according to an embodiment;

FIG. 3 is a diagram illustrating a form in which relationship information between concepts and actions is stored in a database (DB), according to an embodiment;

FIG. 4 is a diagram illustrating a screen in which an electronic device processes a voice input received through an intelligent app, according to an embodiment;

FIG. 5 is a diagram illustrating an operation in which an electronic device processes an utterance of a user, according to an embodiment;

FIG. 6 is a schematic block diagram of an electronic device according to an embodiment;

FIG. 7 is a diagram illustrating a session according to an embodiment;

FIGS. 8, 9, and 10 are diagrams illustrating an operation in which an electronic device processes a user utterance, according to an embodiment; and

FIG. 11 is a flowchart of an operating method of an electronic device, according to an embodiment.

### DETAILED DESCRIPTION

Hereinafter, embodiments will be described in detail with reference to the accompanying drawings. When describing the embodiments with reference to the accompanying drawings, like reference numerals refer to like elements, and a repeated description related thereto is omitted.

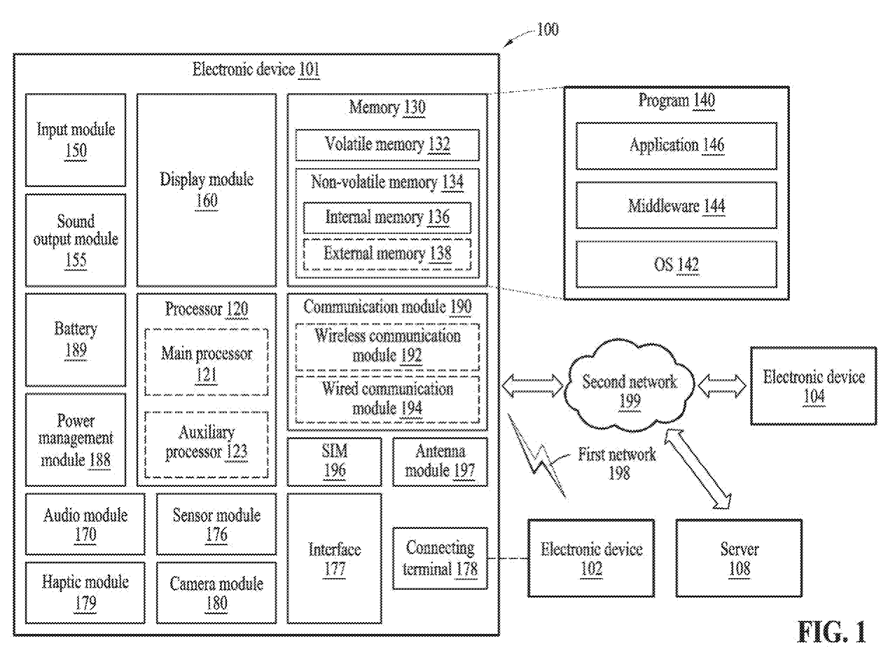

FIG. 1 is a block diagram illustrating an electronic device 101 in a network environment 100, according to an embodiment.

Referring to FIG. 1, the electronic device 101 in the network environment 100 may communicate with an electronic device 102 via a first network 198 (e.g., a short-range wireless communication network), and/or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include at least one processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120 and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134.

According to an embodiment, the processor 120 may be implemented as circuitry (e.g., processing circuitry), such as a system-on-chip (SoC) or an integrated circuit (IC). The processor 120 may include one or more processors. For example, the processor 120 may include a combination of one or more processors, such as a central processing unit (CPU), a graphics processing unit (GPU), a microprocessor unit (MPU), an application processor (AP), and a communication processor (CP).

According to an embodiment, the processor 120 may include a main processor 121 (e.g., a CPU or an AP), or an auxiliary processor 123 (e.g., a GPU, a neural processing unit (NPU), an image signal processor (ISP), a sensor hub processor, or a CP) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto.

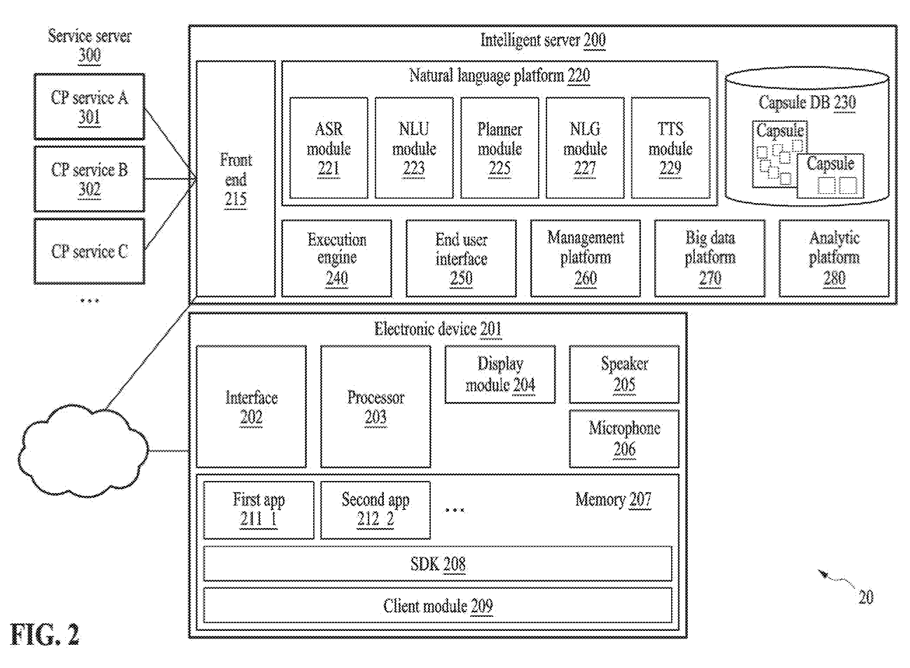

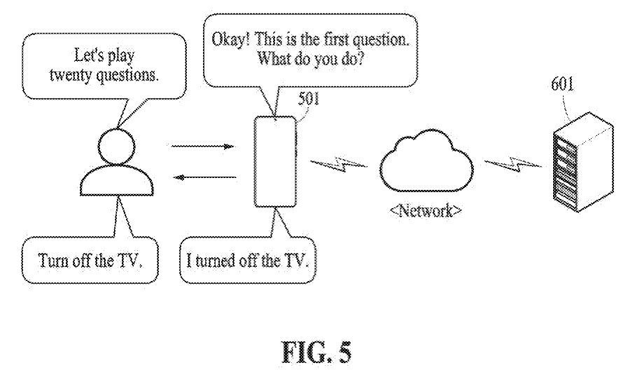

According to an embodiment, the memory 130 may include one or more memories. The instructions stored in the memory 130 may be stored in a single memory. The instructions stored in the memory 130 may be divided and stored in a plurality of memories. The instructions stored in the memory 130 may be executed by the processor 120 individually or collectively to cause the electronic device 101 (e.g., an electronic device 201 of FIG. 2 and an electronic device 501 of FIG. 5) to perform and/or control a method of processing a user utterance described with reference to FIGS. 5 to 11. The instructions stored in the memory 130 may be executed by a plurality of processors individually or collectively to cause the electronic device 101 (e.g., an electronic device 201 of FIG. 2 and an electronic device 501 of FIG. 5) to perform and/or control a method of processing a user utterance described with reference to FIGS. 5 to 11. According to an embodiment, the memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., the electronic device 102) (e.g., a speaker or headphone) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

Referring to FIG. 2, an integrated intelligence system 20 of an embodiment may include an electronic device 201 (e.g., the electronic device 101 of FIG. 1), an intelligent server 200 (e.g., the server 108 of FIG. 1), and a service server 300 (e.g., the server 108 of FIG. 1).

The electronic device 201 of an embodiment may be a terminal device (or an electronic device) connectable to the Internet, and may be, for example, a mobile phone, a smartphone, a personal digital assistant (PDA), a notebook computer, a television (TV), a white home appliance, a wearable device, a head-mounted display (HMD), or a smart speaker.

According to the shown embodiment, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), memory 207 (e.g., the memory 130 of FIG. 1), and/or at least one processor 203 (e.g., the processor 120 of FIG. 1). The components listed above may be operatively or electrically connected to each other.

The communication interface 202 of an embodiment may be connected to an external device and configured to transmit and receive data to and from the external device. The microphone 206 of an embodiment may receive a sound (e.g., a user utterance) and convert the sound into an electrical signal. The speaker 205 of an embodiment may output the electrical signal as a sound (e.g., a voice).

The display module 204 of an embodiment may be configured to display an image or video. The display module 204 of an embodiment may also display a graphical user interface (GUI) of an app (or an application program) being executed. The display module 204 of an embodiment may receive a touch input through a touch sensor. For example, the display module 204 may receive a text input through the touch sensor in an on-screen keyboard area displayed on the display module 204.

The memory 207 of an embodiment may store a client module 209, a software development kit (SDK) 208, and a plurality of apps 211. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of apps 211 stored in the memory 207 of an embodiment may be programs for performing designated functions. According to an embodiment, the plurality of apps 211 may include a first app 211_1 and a second app 211_2. According to an embodiment, each of the plurality of apps 211 may include a plurality of actions for performing a designated function. For example, the apps may include an alarm app, a messaging app, and/or a scheduling app. According to an embodiment, the plurality of apps 211 may be executed by the processor 203 to sequentially execute at least a portion of the plurality of actions.

The processor 203 of an embodiment may control the overall operation of the electronic device 201. For example, the processor 203 may be electrically connected to the communication interface 202, the microphone 206, the speaker 205, and the display module 204 to perform a designated operation.

According to an embodiment, the processor 203 may be implemented as circuitry (e.g., processing circuitry), such as an SoC or an IC. The processor 203 may include one or more processors. For example, the processor 203 may include a combination of one or more processors, such as a CPU, a GPU, an MPU, an AP, and a CP.

The processor 203 of an embodiment may also perform the designated function by executing the program stored in the memory 207. For example, the processor 203 may execute at least one of the client module 209 or the SDK 208 to perform the following operation for processing a user input. The processor 203 may control the actions of the plurality of apps 211 through, for example, the SDK 208. The following operation described as an operation of the client module 209 or the SDK 208 may be an operation by an execution of the processor 203.

According to an embodiment, the memory 207 may include one or more memories. The instructions stored in the memory 207 may be stored in a single memory. The instructions stored in the memory 207 may be divided and stored in a plurality of memories. The instructions stored in the memory 207 may be executed by the processor 203 individually or collectively to cause the electronic device 201 (e.g., the electronic device 101 of FIG. 1 and an electronic device 501 of FIG. 5) to perform and/or control a method of processing a user utterance described with reference to FIGS. 5 to 11. The instructions stored in the memory 207 may be executed by a plurality of processors individually or collectively to cause the electronic device 201 (e.g., the electronic device 101 of FIG. 1 and an electronic device 501 of FIG. 5) to perform and/or control a method of processing a user utterance described with reference to FIGS. 5 to 11.

The client module 209 of an embodiment may receive a user input. For example, the client module 209 may receive a voice signal corresponding to a user utterance sensed through the microphone 206. In another example, the client module 209 may receive a touch input sensed through the display module 204. In still another example, the client module 209 may receive a text input sensed through a keyboard or an on-screen keyboard. In addition, the client module 209 may receive various types of user inputs sensed through an input module included in the electronic device 201 or an input module connected to the electronic device 201. The client module 209 may transmit the received user input to the intelligent server 200. The client module 209 may transmit state information of the electronic device 201 together with the received user input to the intelligent server 200. The state information may be, for example, execution state information of an app.

The client module 209 of an embodiment may receive a result corresponding to the received user input. For example, when the intelligent server 200 is capable of calculating a result corresponding to the received user input, the client module 209 may receive the result corresponding to the received user input. The client module 209 may display the received result on the display module 204. Furthermore, the client module 209 may output the received result in an audio form through the speaker 205.

The client module 209 of an embodiment may receive a plan corresponding to the received user input. The client module 209 may display, on the display module 204, the results of executing a plurality of actions of an app according to the plan. For example, the client module 209 may sequentially display the results of executing the plurality of actions on the display module 204 and output the results in an audio form through the speaker 205. In another example, the electronic device 201 may display only a portion of the results of executing the plurality of actions (e.g., a result of the last action) on the display module 204 and output the portion of the results in an audio form through the speaker 205.

According to an embodiment, the client module 209 may receive a request for obtaining information necessary for calculating a result corresponding to the user input from the intelligent server 200. According to an embodiment, the client module 209 may transmit the necessary information to the intelligent server 200 in response to the request.

The client module 209 of an embodiment may transmit information on the results of executing the plurality of actions according to the plan to the intelligent server 200. The intelligent server 200 may confirm that the received user input is correctly processed using the information on the results.

The client module 209 of an embodiment may include a speech recognition module. According to an embodiment, the client module 209 may recognize, through the speech recognition module, a voice input for performing a limited function. For example, the client module 209 may execute an intelligent app for processing a voice input to perform an organic operation through a designated input (e.g., Wake up!).

The intelligent server 200 of an embodiment may receive information regarding a user voice input from the electronic device 201 through a communication network. According to an embodiment, the intelligent server 200 may change data regarding the received voice input into text (e.g., text data). According to an embodiment, the intelligent server 200 may generate a plan for performing a task corresponding to the user voice input, based on the text.

According to an embodiment, the plan may be generated by an AI system. The AI system may be a rule-based system or a neural network-based system (e.g., a feedforward neural network (FNN) or an RNN). Alternatively, the AI system may be a combination thereof or other AI systems. According to an embodiment, the plan may be selected from a set of pre-defined plans or may be generated in real time in response to a user request. For example, the AI system may select at least one plan from the pre-defined plans.

The intelligent server 200 of an embodiment may transmit a result according to the generated plan to the electronic device 201 or transmit the generated plan to the electronic device 201. According to an embodiment, the electronic device 201 may display the result according to the plan on the display module 204. According to an embodiment, the electronic device 201 may display a result of executing an action according to the plan on the display module 204.

The intelligent server 200 of an embodiment may include a front end 215, a natural language platform 220, a capsule database (DB) 230, an execution engine 240, an end user interface (UI) 250, a management platform 260, a big data platform 270, or an analytic platform 280.

The front end 215 of an embodiment may receive a user input received from the electronic device 201. The front end 215 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 of an embodiment may convert data regarding a voice input received from the electronic device 201 into text (e.g., text data). The NLU module 223 of an embodiment may identify the intent of the user using text of the voice input. For example, the NLU module 223 may identify the intent of the user by performing syntactic analysis or semantic analysis on an input of the user in the form of text data. The NLU module 223 of an embodiment may identify the meaning of a word extracted from the input of the user using a linguistic feature (e.g., a grammatical element) of a morpheme or a phrase and may determine the intent of the user by matching the identified meaning of the word to the intent. That is, the NLU module 223 may obtain intent information corresponding to a user utterance. The intent information may be information indicating the intent of the user determined by interpreting the text. The intent information may include information indicating an action (or a function) that the user intends to execute using a device. The intent information may also be referred to as goal information. A slot may be detailed information regarding the intent information. The slot may be a parameter necessary for an action according to the intent of the user. The slot may also be variable information necessary for an action.

The planner module 225 of an embodiment may generate a plan using the intent determined by the NLU module 223 and a parameter (e.g., a slot). According to an embodiment, the planner module 225 may determine a plurality of domains necessary for a task based on the determined intent. The planner module 225 may determine a plurality of actions included in each of the plurality of domains determined based on the intent. According to an embodiment, the planner module 225 may determine a parameter necessary for the determined plurality of actions, or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically). For example, the planner module 225 may determine an execution order of the plurality of actions determined based on the intent of the user, based on the plurality of concepts. That is, the planner module 225 may determine the execution order of the plurality of actions based on the parameter necessary for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 of an embodiment may change designated information into a text form. The information changed to the text form may be in the form of a natural language utterance. The TTS module 229 of an embodiment may change information in a text form into information in a voice form.

According to an embodiment, some or all the functions of the natural language platform 220 may be implemented in the electronic device 201 as well.

The capsule DB 230 may store information on the relationships between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when a plurality of plans corresponding to the user input is present. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 201. According to an embodiment, the capsule DB 230 may include a vocabulary registry that stores vocabulary information included in capsule information. According to an embodiment, the capsule DB 230 may include a dialog registry that stores information regarding a dialog (or an interaction) with the user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with the user. The developer tool may include a follow-up editor capable of activating a subsequent goal and editing a subsequent utterance that provides hints. The subsequent goal may be determined based on a currently configured goal, a preference of the user, or an environmental condition. In an embodiment, the capsule DB 230 may be implemented in the electronic device 201 as well.

The execution engine 240 may calculate a result using the generated plan. The end UI 250 may transmit the calculated result to the electronic device 201. Accordingly, the electronic device 201 may receive the result and provide the received result to the user. The management platform 260 of an embodiment may manage information used by the intelligent server 200. The big data platform 270 of an embodiment may collect data of the user. The analytic platform 280 of an embodiment may manage a quality of service (QoS) of the intelligent server 200. For example, the analytic platform 280 may manage the components and processing rate (or efficiency) of the intelligent server 200.

The service server 300 of an embodiment may provide a service (e.g., food ordering or hotel reservation) designated to the electronic device 201. According to an embodiment, the service server 300 may be a server operated by a library administrator. Services, such as CP service A 301 and CP service B 302, of the service server 300 may interact with the front end 210 of the intelligent server 200. The service server 300 of an embodiment may provide, to the intelligent server 200, information to be used for generating a plan corresponding to the received user input. The provided information may be stored in the capsule DB 230. In addition, the service server 300 may provide result information according to the plan to the intelligent server 200.

In the integrated intelligence system 20 described above, the electronic device 201 may provide various intelligent services to the user in response to the user input. The user input may include, for example, an input through a physical button, a touch input, or a voice input.

In an embodiment, the electronic device 201 may provide a speech recognition service through an intelligent app (or a speech recognition app) stored therein. In this case, for example, the electronic device 201 may recognize a user utterance or a voice input received through the microphone and provide a service corresponding to the recognized voice input to the user.

In an embodiment, the electronic device 201 may perform a designated action alone or together with the intelligent server and/or the service server, based on the received voice input. For example, the electronic device 201 may execute an app corresponding to the voice input and perform a designated action through the executed app.

In an embodiment, when the electronic device 201 provides a service together with the intelligent server 200 and/or the service server 300, the electronic device 201 may detect a user utterance using the microphone 206and generate a signal (or voice data) corresponding to the detected user utterance. The electronic device 201 may transmit the voice data to the intelligent server 200 using the communication interface 202.

The intelligent server 200 according to an embodiment may generate, as a response to the voice input received from the electronic device 201, a plan for performing a task corresponding to the voice input or a result of performing an action according to the plan. The plan may include, for example, the plurality of actions for performing the task corresponding to the voice input of the user and the plurality of concepts associated with the plurality of actions. The concepts may be defined as parameters that are input for execution of the plurality of actions or result values that are output by execution of the plurality of actions. The plan may include connection information on connections between the plurality of actions and the plurality of concepts.

The electronic device 201 of an embodiment may receive the response using the communication interface 202. The electronic device 201 may output a voice signal generated inside the electronic device 201 to the outside using the speaker 205 or may output an image generated inside the electronic device 201 to the outside using the display module 204.

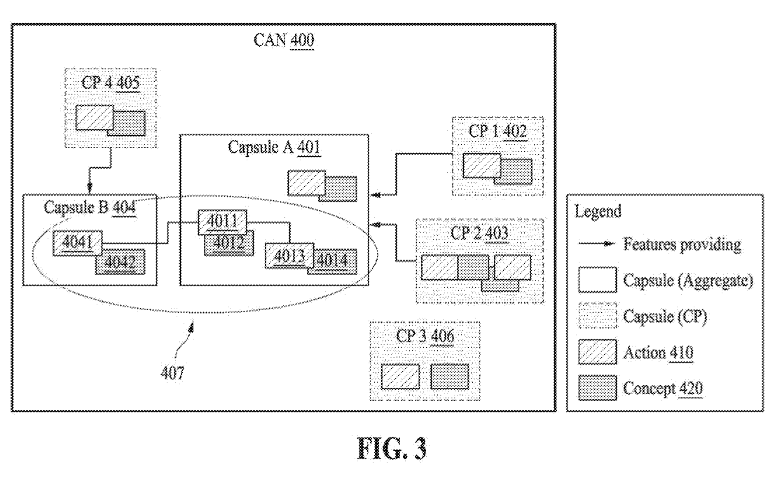

FIG. 3 is a diagram illustrating a form in which relationship information between concepts and actions is stored in a DB, according to various embodiments.

A capsule DB (e.g., the capsule DB 230 of FIG. 2) of an intelligent server (e.g., the intelligent server 200 of FIG. 2) may store capsules in the form of a CAN 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains. According to an embodiment, one capsule (e.g., the capsule A 401) may correspond to one domain (e.g., a location (geo)). Furthermore, one capsule may correspond to at least one service provider (e.g., CP 1 402 or CP 2 403) for performing a function for a domain related to the capsule. According to an embodiment, one capsule may include at least one action 410 and at least one concept 420 to perform a designated function. The CAN 400 may store other information such as CP 3 406. In addition, the capsule B 404 may correspond to a service provider (e.g., CP 4 405).

A natural language platform (e.g., the natural language platform 220 of FIG. 2) may generate a plan for performing a task corresponding to the received voice input, using the capsules stored in the capsule DB. For example, a planner module (e.g., the planner module 225 of FIG. 2) of the natural language platform may generate a plan using the capsules stored in the capsule DB. For example, a plan 407 may be generated using actions 4011 and 4013 and concepts 4012 and 4014 of the capsule A 401 and an action 4041 and a concept 4042 of the capsule B 404.

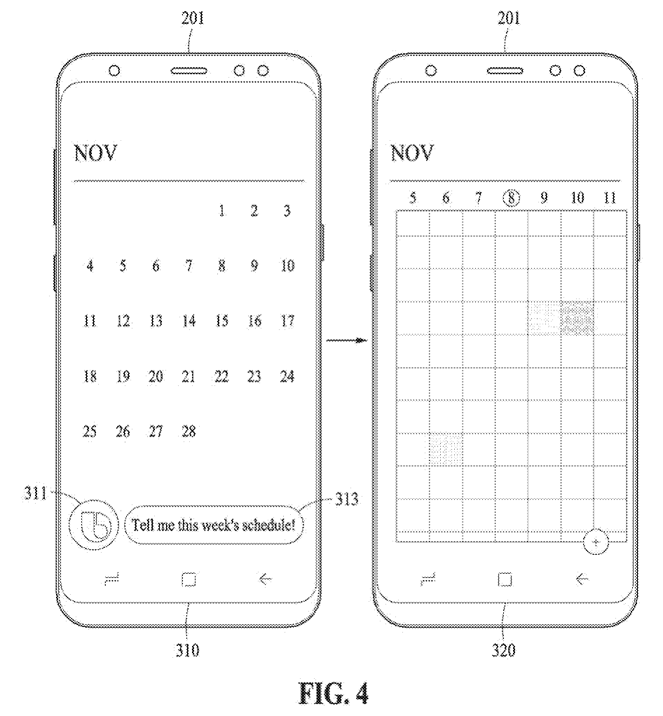

FIG. 4 is a diagram illustrating a screen in which an electronic device processes a voice input received through an intelligent app, according to various embodiments.

The electronic device 201 may execute an intelligent app to process a user input through an intelligent server (e.g., the intelligent server 200 of FIG. 2).

According to an embodiment, on a screen 310, when a designated voice input (e.g., Wake up!) is recognized or an input through a hardware key (e.g., a dedicated hardware key) is received, the electronic device 201 may execute the intelligent app for processing the voice input. The electronic device 201 may execute the intelligent app, for example, in a state in which a scheduling app is executed. According to an embodiment, the electronic device 201 may display an object (e.g., an icon) 311 corresponding to the intelligent app on the display module 204 (e.g., the display module 160 of FIG. 1 or the display module 204 of FIG. 2). According to an embodiment, the electronic device 201 may receive a voice input by a user utterance. For example, the electronic device 201 may receive a voice input of “Tell me this week’s schedule!” According to an embodiment, the electronic device 201 may display, on the display module 204, a UI (e.g., an input window) 313 of the intelligent app in which text (e.g., text data) of the received voice input is displayed.

According to an embodiment, on a screen 320, the electronic device 201 may display a result corresponding to the received voice input on the display module 204. For example, the electronic device 201 may receive a plan corresponding to the received user input and display “This week’s schedule” on the display module 204 according to the plan.

FIG. 5 is a diagram illustrating an operation in which an electronic device processes an utterance of a user, according to an embodiment.

Referring to FIG. 5, according to an embodiment, an electronic device 501 may include at least some components of the electronic device 101 described with reference to FIG. 1 and the electronic device 201 described with reference to FIG. 2. An intelligent server 601 may include at least some components of the intelligent server 200 described with reference to FIG. 2. With respect to the electronic device 501 and the intelligent server 601, repeated descriptions provided with reference to FIGS. 1 to 4 are omitted.

According to an embodiment, the electronic device 501 (e.g., the electronic device 101 of FIG. 1 or the electronic device 201 of FIG. 2) may be connected to the intelligent server 601 (e.g., the intelligent server 200 of FIG. 2) via a LAN, a WAN, a value-added network (VAN), a mobile radio communication network, a satellite communication network, or any combination thereof. The electronic device 501 and the intelligent server 601 may communicate with each other through a wired communication method or a wireless communication method (e.g., a wireless LAN (Wi-Fi), Bluetooth, Bluetooth low energy, ZigBee, Wi-Fi direct (WFD), ultra-wideband (UWB), IrDA, and near field communication (NFC)). The electronic device 501 may perform communication with a peripheral device (e.g., the electronic device 102 or the electronic device 104 of FIG. 1) located around the electronic device 501.

According to an embodiment, the electronic device 501 may be implemented as at least one of a smartphone, a tablet personal computer (PC), a mobile phone, a speaker (e.g., an AI speaker), a video phone, an e-book reader, a desktop PC, a laptop PC, a netbook computer, a workstation, a server, a PDA, a portable multimedia player (PMP), an MP3 player, a mobile medical device, a camera, or a wearable device.

According to an embodiment, the electronic device 501 may obtain a voice signal corresponding to an utterance of the user and may transmit the voice signal to the intelligent server 601. The intelligent server 601 may obtain text (e.g., text data) corresponding to the utterance of the user, based on the voice signal. The text may be obtained by converting a voice part into computer-readable data by performing ASR on the voice signal. The intelligent server 601 may process the utterance of the user using the text. The intelligent server 601 may process the utterance of the user (e.g., perform a task corresponding to the utterance) based on a generative model (e.g., a language model). The intelligent server 601 may provide a response corresponding to the task performance result to the electronic device 501. The intelligent server 601 may be implemented as software. A portion or the entirety of the intelligent server 601 may be implemented in the electronic device 501. That is, on-device AI for processing an utterance without communication with the intelligent server 601 may be installed on the electronic device 501.

According to an embodiment, the electronic device 501 may perform a task (e.g., a unit designated by the manufacturer of the electronic device 501 equipped with a voice assistant) corresponding to a user input (e.g., a user utterance). The electronic device 501 may be an electronic device in which the generative model (e.g., a language model) is integrated into a voice assistant function.

According to an embodiment, by integrating the generative model (e.g., a language model) into the voice assistant function, the electronic device 501 may adaptively respond to various inputs of the user. By integrating the generative model into the voice assistant function, the electronic device 501 may identify preferences and habits of the user and provide a personalized voice assistant function. The electronic device 501 may also resolve an issue (e.g., hallucination) that occurs when integrating the generative model (e.g., a language model) into the voice assistant function.

According to an embodiment, the electronic device 501 may use prompt text to enhance the availability of the generative model. The prompt text may be text that transmits an input or request of the user to the generative model (e.g., a language model). The generative model may analyze the prompt text and generate an appropriate response accordingly. Properly written prompt text may help the generative model output the text desired by the user.

According to an embodiment, the electronic device 501 may efficiently manage a session of the generative model (or a voice assistant) using the prompt text. The session may be a unit that facilitates the management of interactions between the user and the electronic device. While one session is maintained, the electronic device 501 may track and store an interaction (e.g., an input (e.g., an utterance) of the user and an output (e.g., a response) of the electronic device) (e.g., a dialog) with the user. While one session is maintained, the electronic device 501 may maintain the context of the dialog and provide a connected response to the user.

According to an embodiment, the electronic device 501 may differentiate the configurations of the prompt text according to the maintenance of the session or the separation of the session. When maintaining the session, the electronic device 501 may configure the prompt text based on the interaction (e.g., an existing input and/or an existing output) with the user. The maintenance of the session may be performed automatically (or mechanically) unless otherwise instructed by the user. When separating the session (e.g., creating a new session), the electronic device 501 may configure the prompt text without using an existing input and/or an existing output. The separation of the session (e.g., creation of a new session) may be performed by the instruction of the user and/or the determination of the electronic device.

According to an embodiment, the session may refer to a time interval in which the interaction between the user and/or the electronic device 501 is remembered (or stored). The session may include the interaction between the user and/or the electronic device 501. Furthermore, the session may be distinguished according to one or more combinations of a condition (e.g., a correlation), meaning, type, and/or form of the interaction between the user and/or the electronic device 501.

According to an embodiment, the session may be divided into a single turn and a multi-turn. The single turn may indicate that the session includes a single turn (or round). The single-turn session may include an input of one user and an output of one electronic device. The multi-turn may indicate that the session includes a plurality of turns (or rounds). The multi-turn session may include inputs of a plurality of users and outputs of a plurality of electronic devices.

According to an embodiment, during the multi-turn session, the electronic device 501 may maintain the session (e.g., track the interaction with the user and configure the prompt text based on the tracked interaction). While the multi-turn session is maintained, the electronic device 501 may track the interaction with the user. The electronic device 501 may consider the content and/or context of a previous turn and may provide a connected response to the user.

Recent technologies may have developed to support the multi-turn session. The electronic device 501 according to an embodiment may be designed not to support an unconditional multi-turn session. The electronic device 501 may separate the session (e.g., create a new session) without an explicit instruction (e.g., create a new session or clear context) from the user.

Referring to FIG. 5, according to an embodiment, the electronic device 501 may receive a first input (e.g., an utterance) (e.g., “Let’s play twenty questions”) from the user. The electronic device 501 may create a first session in response to receiving the first input. Based on the generative model (e.g., a language model), the electronic device 501 may provide the user with a first output (e.g., “Okay! This is the first question. What do you do?”) corresponding to the first input (e.g., “Let’s play twenty questions”). The first output (e.g., “Okay! This is the first question. What do you do?”) may be provided to the user after a task (e.g., executing a chatbot) corresponding to the first input (e.g., “Let’s play twenty questions”) is performed. The electronic device 501 may receive a second input (e.g., an utterance) (e.g., “Turn off the TV”) from the user. In response to receiving the second input, the electronic device 501 may create a second session that is different from the first session when a condition (e.g., a correlation) between the first input and the second input and a condition (e.g., a correlation) between the first output and the second input are satisfied. The second session may be created when both the correlation between the first input (e.g., “Let’s play twenty questions”) and the second input (e.g., “Turn off the TV”) and the correlation between the first output (e.g., “Okay! This is the first question. What do you do?”) and the second input (e.g., “Turn off the TV”) are less than a threshold value. The electronic device 501 may provide the user with a second output (e.g., “I turned off the TV”) corresponding to the second input (e.g., “Turn off the TV”), based on the generative model (e.g., a language model). The second output (e.g., “I turned off the TV”) may be provided to the user after a task (e.g., TV off) corresponding to the second input (e.g., “Turn off the TV”) is performed.

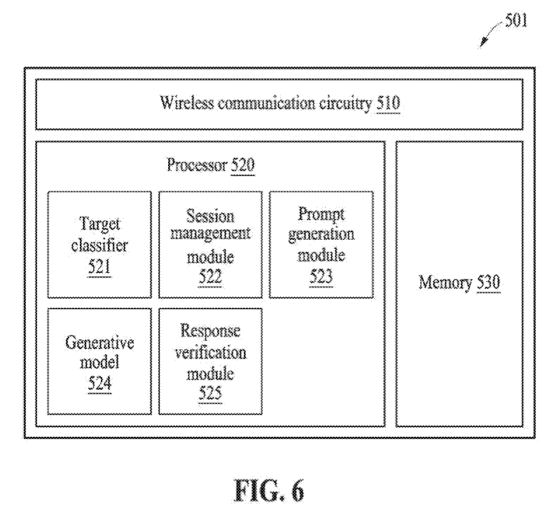

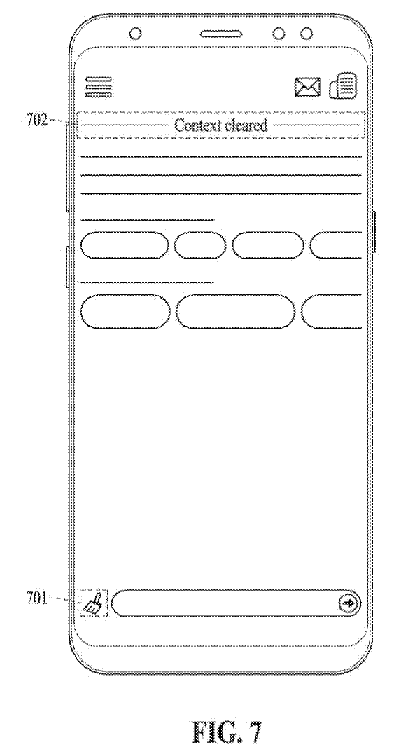

FIG. 6 is a schematic block diagram of an electronic device according to an embodiment, and FIG. 7 is a diagram illustrating a session according to an embodiment.

Referring to FIG. 6, according to an embodiment, the electronic device 501 may include at least some components of the electronic device 101 described with reference to FIG. 1 and the electronic device 201 described with reference to FIG. 2. As described above, on-device AI for processing an utterance without communication with an intelligent server (e.g., the intelligent server 200 of FIG. 2 and the intelligent server 601 of FIG. 5) may be installed on the electronic device 501. With respect to the electronic device 501, repeated descriptions provided with reference to FIGS. 1 to 5 are omitted.

According to an embodiment, the electronic device 501 may include wireless communication circuitry 510 (e.g., the wireless communication module 192 of FIG. 1). The electronic device 501 may include a processor 520 (e.g., the processor 120 of FIG. 1 or the processor 203 of FIG. 2). The electronic device 501 may include memory 530 (e.g., the memory 130 of FIG. 1 or the memory 207 of FIG. 2). The processor 520 (e.g., an AP) may execute one or more instructions by accessing the memory 530. The processor 520 may cause the electronic device 501 to provide a response to a user. The memory 530 may store various types of data used by at least one component (e.g., the processor 520) of the electronic device 501.

According to an embodiment, the processor 520 may be implemented as circuitry (e.g., processing circuitry), such as an SoC or an IC. The processor 520 may include one or more processors. For example, the processor 520 may include a combination of one or more processors, such as a CPU, a GPU, an MPU, an AP, and a CP.

According to an embodiment, the memory 530 may include one or more memories. The instructions stored in the memory 530 may be stored in a single memory. The instructions stored in the memory 530 may be divided and stored in a plurality of memories. The instructions stored in the memory 530 may be individually or collectively executed by the processor 520 to cause the electronic device 501 (e.g., the electronic device 101 of FIG. 1 and the electronic device 201 of FIG. 2) to perform and/or control a method of processing a user utterance described with reference to FIGS. 5 to 11. The instructions stored in the memory 530 may be individually or collectively executed by a plurality of processors to cause the electronic device 501 (e.g., the electronic device 101 of FIG. 1 and the electronic device 201 of FIG. 2) to perform and/or control a method of processing a user utterance described with reference to FIGS. 5 to 11.

According to an embodiment, the electronic device 501 may receive an input of the user. The electronic device 501 may determine whether the input of the user may be processed by the electronic device 501 based on a target classifier 521. The target classifier 521 may reject a non-target utterance. An existing voice assistant that does not use a generative model (e.g., a language model) may determine (e.g., match) whether the input of the user is a target to be processed, based on predefined information. When the input of the user is not a target to be processed, the existing voice assistant has no choice but to provide a rejection response (e.g., “This action is not supported”). The electronic device 501 according to an embodiment may be an electronic device in which the generative model (e.g., a language model) is integrated into a voice assistant function. By integrating the generative model into the voice assistant function, the electronic device 501 may adaptively respond to various inputs of the user. However, the electronic device 501 may need to filter out inappropriate inputs of the user (e.g., profanity, vulgar language, and hate speech). The electronic device 501 may filter out (e.g., classify) inappropriate inputs of the user based on the target classifier 521. The target classifier 521 may use information about a predefined rejection target, a personal data sync service (PDSS) (e.g., personal data of the user) (e.g., contact information, installed applications, and shortcut commands), and a range supported by the electronic device 501.

According to an embodiment, the electronic device 501 may determine a session to process the input of the user based on a session management module 522. For example, the session management module 522 may create a new session. For example, the session management module 522 may determine to process the input of the user through an existing session. The session may be a concept used in a language model-based chatbot. The session may be a unit for easily managing interactions between the user and the electronic device 501. While one session is maintained, the electronic device 501 may track and store an interaction (e.g., an input (e.g., an utterance) of the user and an output (e.g., a response) of the electronic device) (e.g., a dialog) with the user.

According to an embodiment, the electronic device 501 may maintain the context of a dialog while one session is maintained and may create a new session when the input of the user deviates from the existing context. For example, the electronic device 501 that receives consecutive inputs (e.g., utterances) (e.g., “Turn on the TV,” “Turn on channel 22,” “Turn up the volume,” and “Send a text message to Samsung Kim”) may manage the inputs (e.g., “Turn on the TV,” “Turn on channel 22,” and “Turn up the volume”) as one session, and the input (e.g., “Send a text message to Samsung Kim”) as a separate session. Typically, the session may be maintained automatically (or mechanically) unless otherwise instructed by the user. The separation of the session (e.g., creation of a new session) may require an explicit instruction (e.g., an input to a new session creation interface 701 of FIG. 7 or an utterance, “end session”) from the user, which may be cumbersome for the user (e.g., see 702 of FIG. 7 for a response of the electronic device to an explicit instruction from the user). The electronic device 501 according to an embodiment may separate the session (e.g., create a new session) without an explicit instruction from the user.

Unlike the language model-based chatbot, in a voice assistant, a one-time command may make up the majority of the input of the user. That is, while the language model-based chatbot requires an approach to the method of maintaining a long session, the language model-based voice assistant may require an approach to the method of separating a session. The electronic device 501 according to an embodiment may not support unconditional session maintenance.

According to an embodiment, the session management module 522 may determine whether to create a new session, based on a correlation between a current input and an existing input/output. For example, when the correlation between the current input and the existing input/output is less than a threshold value, the session management module 522 may create a new session. For example, when the correlation between the current input and the existing input/output is greater than or equal to the threshold value, the session management module 522 may process the current input through an existing session. The correlation between the current input and the existing input/output may be determined based on a similarity between utterances and/or reinforcement learning with human feedback (RLHF). The similarity between utterances may be determined by considering the overlap between words or the form of words. RLHF may perform training based on a score of the user, allowing a model to imitate human judgment. For example, in consecutive utterances (e.g., ‘Tell me the weather in Haeundae’ and ‘Tell me about famous restaurants there’), although ‘weather’ and ‘famous restaurants’ have few connections in terms of words, a person may determine that consistent contextual utterances are input.

According to an embodiment, the session management module 522 may use both short-term memory and long-term memory. The short-term memory may store dialogs from a current session, and the long-term memory may store dialogs from a previous session. Using the long-term memory, the session management module 522 may also resume the previous session (e.g., a terminated session).

According to an embodiment, the electronic device 501 may generate (e.g., configure) prompt text based on a prompt generation module 523. The prompt text may be text that transmits an input or request of the user to a generative model 524 (e.g., a language model). The generative model 524 may analyze the prompt text and generate an appropriate response accordingly. Properly written prompt text may help the generative model 524 output the text desired by the user. When a current input is managed through the same session as an existing input, the prompt generation module 523 may configure the prompt text based on an existing input/output. When the current input is managed through a different session from the existing input, the prompt generation module 523 may configure the prompt text without using the existing input/output. When the current input is managed through a different session from the existing input, the prompt generation module 523 may not generate the prompt text.

According to an embodiment, the electronic device 501 may generate text data based on the generative model 524 (e.g., a language model). The generative model 524 may generate the text data based on the prompt text. The text data may include intent information, a slot, and/or an executable application programming interface (API).

According to an embodiment, the electronic device 501 may verify the text data based on a response verification module 525. The response verification module 525 may review the appropriateness of the text data. The response verification module 525 may review grammatical errors in the text data.

According to an embodiment, the response verification module 525 may verify the text data and perform rejection. The response verification module 525 may review the writing style of the text data (e.g., language and politeness), the appropriateness of a persona (e.g., a persona of a language model), the presence of hallucination (e.g., an issue of generating or providing information, events, and/or situations that are unrelated to reality), and a fallback mechanism (e.g., a mechanism generally used when an appropriate response to an input of the user may not be generated). When it is determined that the text data is inappropriate, the response verification module 525 may instruct the generative model 524 to regenerate the text data.

According to an embodiment, the electronic device 501 may be an electronic device in which the generative model (e.g., a language model) is integrated into the voice assistant function. The electronic device 501 may efficiently manage a session of the generative model (or a voice assistant). The electronic device 501 may be designed not to support an unconditional multi-turn session. The electronic device 501 may separate the session (e.g., create a new session) without an explicit instruction (e.g., create a new session or clear context) from the user. The electronic device 501 may resolve an issue (e.g., hallucination) that occurs when integrating the generative model (e.g., a language model) into the voice assistant function.

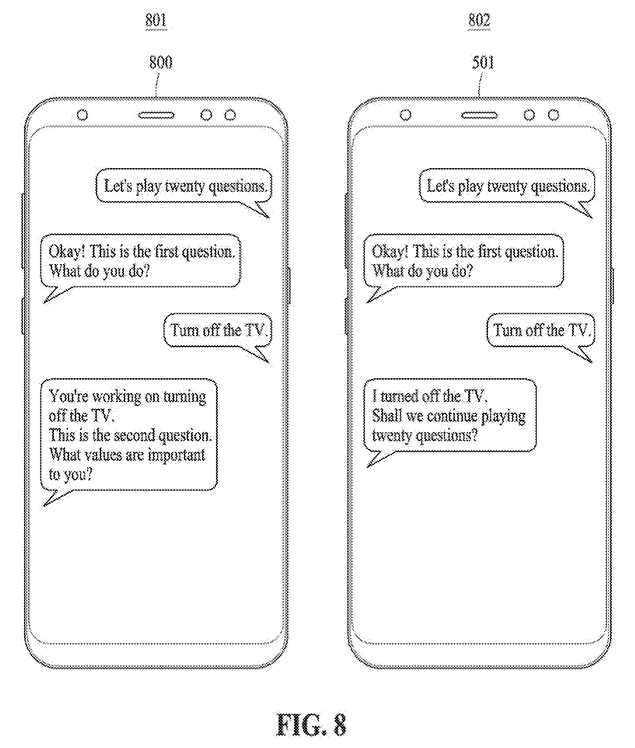

FIGS. 8 to 10 are diagrams illustrating an operation in which an electronic device processes a user utterance, according to an embodiment.

Referring to FIG. 8, in a situation 801, an electronic device 800 may receive a first input (e.g., an utterance) (e.g., “Let’s play twenty questions”) from a user. The electronic device 800 may create a first session (e.g., a chatbot session) in response to receiving the first input. Based on a generative model (e.g., a language model), the electronic device 800 may provide the user with a first output (e.g., “Okay! This is the first question. What do you do?”) corresponding to the first input (e.g., “Let’s play twenty questions”). The first output (e.g., “Okay! This is the first question. What do you do?”) may be provided to the user after a task (e.g., executing a chatbot) corresponding to the first input (e.g., “Let’s play twenty questions”) is performed. The electronic device 800 may receive a second input (e.g., an utterance) (e.g., “Turn off the TV”) from the user. Since the electronic device 800 is operating in the first session (e.g., a chatbot session) and there is no explicit instruction from the user regarding session separation, the electronic device 800 may generate a second output (e.g., “You’re working on turning off the TV. This is the second question. What values are important to you?”) corresponding to the second input in the first session (e.g., a chatbot session) and may provide the second output to the user. The user who wants to control the TV may receive an inappropriate response from the electronic device 800. The user of the electronic device 800 may first need to perform explicit session separation to control the TV.

According to an embodiment, in a situation 802, the electronic device 501 may receive the first input (e.g., an utterance) (e.g., “Let’s play twenty questions”) from the user. The electronic device 501 may create the first session (e.g., a chatbot session) in response to receiving the first input. Based on the generative model (e.g., a language model), the electronic device 501 may provide the user with the first output (e.g., “Okay! This is the first question. What do you do?”) corresponding to the first input (e.g., “Let’s play twenty questions”). The first output (e.g., “Okay! This is the first question. What do you do?”) may be provided to the user after the task (e.g., executing a chatbot) corresponding to the first input (e.g., “Let’s play twenty questions”) is performed. The electronic device 501 may receive the second input (e.g., an utterance) (e.g., “Turn off the TV”) from the user. In response to receiving the second input, the electronic device 501 may create a second session (e.g., an Internet of Things (IoT) session) that is different from the first session (e.g., a chatbot session) when a condition (e.g., a correlation) between the first input and the second input and a condition (e.g., a correlation) between the first output and the second input are satisfied. The second session may be created when both the correlation between the first input (e.g., “Let’s play twenty questions”) and the second input (e.g., “Turn off the TV”) and the correlation between the first output (e.g., “Okay! This is the first question. What do you do?”) and the second input (e.g., “Turn off the TV”) are less than a threshold value. The electronic device 501 may provide the user with a second output (e.g., “I turned off the TV. Shall we continue playing twenty questions?”) corresponding to the second input (e.g., “Turn off the TV”), based on the generative model (e.g., a language model). The second output (e.g., “I turned off the TV. Shall we continue playing twenty questions?”) may be provided to the user after a task (e.g., TV off) corresponding to the second input (e.g., “Turn off the TV”) is performed.

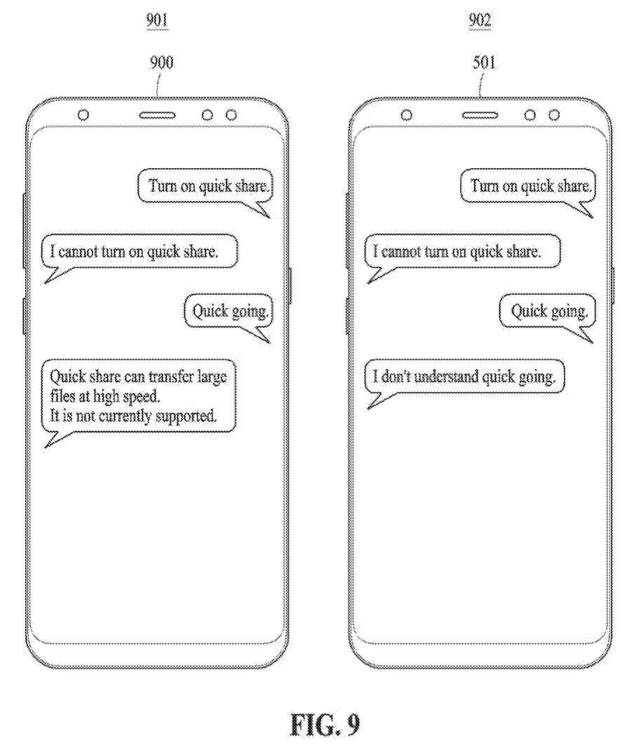

Referring to FIG. 9, in a situation 901, an electronic device 900 may receive a first input (e.g., an utterance) (e.g., “Turn on quick share”) from the user. The electronic device 900 may create a first session (e.g., a device control session) in response to receiving the first input. Based on the generative model (e.g., a language model), the electronic device 900 may provide the user with a first output (e.g., “I cannot turn on quick share”) corresponding to the first input (e.g., “Turn on quick share”). The electronic device 900 may provide the first output (e.g., “I cannot turn on quick share”) because the electronic device 900 is not capable of performing a task (e.g., quick share on) corresponding to the first input (e.g., “Turn on quick share”) (for example, a device does not support quick share). The electronic device 900 may receive a second input (e.g., an utterance) (e.g., “quick going”) from the user. The electronic device 900 may maintain the first session based on a correlation (e.g., a similarity between utterances) (e.g., the overlap between words or form of words) between the first input (e.g., “Turn on quick share”) and the second input (e.g., “quick going”). The electronic device 900 may determine that the second input (e.g., “quick going”) is a subsequent utterance to the first input (e.g., “Turn on quick share”) and generate an inappropriate second output (e.g., “Quick share can transfer large files at a high speed. It is not currently supported”).

According to an embodiment, in a situation 902, the electronic device 501 may receive the first input (e.g., an utterance) (e.g., “Turn on quick share”) from the user. The electronic device 501 may create the first session (e.g., a device control session) in response to receiving the first input. Based on the generative model (e.g., a language model), the electronic device 501 may provide the user with the first output (e.g., “I cannot turn on quick share”) corresponding to the first input (e.g., “Turn on quick share”). The electronic device 501 may provide the first output (e.g., “I cannot turn on quick share”) because the electronic device 501 is not capable of performing the task (e.g., quick share on) corresponding to the first input (e.g., “Turn on quick share”) (for example, a device does not support quick share). The electronic device 501 may receive the second input (e.g., an utterance) (e.g., “quick going”) from the user. The electronic device 501 may determine a correlation between the first input (e.g., “Turn on quick share”) and the second input (e.g., “quick going”). The electronic device 501 may be trained based on RLHF. The electronic device 501 may distinguish between the first input (e.g., “Turn on quick share”) to control a device and the second input (e.g., “quick going”) that has no meaning. The electronic device 501 may generate a second output (e.g., “I don’t understand quick going”) corresponding to the second input (e.g., “quick going”), based on the generative model (e.g., a language model). The electronic device 501 may provide the second output (e.g., “I don’t understand quick going”) to the user.

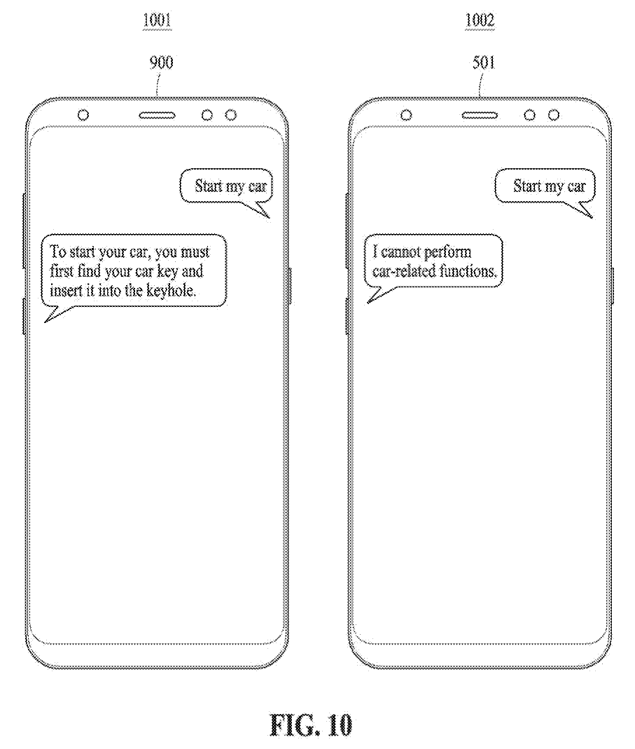

Referring to FIG. 10, in a situation 1001, an electronic device 1000 may receive an input (e.g., an utterance) (e.g., “Start my car”) from the user. The electronic device 1000, which is not capable of performing vehicle control, may need to provide a rejection response to the input (e.g., “Start my car”). However, a language model used in the electronic device 1000 may be trained based on a corpus that does not target the electronic device 1000. The electronic device 1000 may not explicitly reject the vehicle control request but may instead generate a vehicle-related response (e.g., “To start your car, you must first find your car key and insert it into the keyhole”). The electronic device 1000 may be confusing to the user due to the lack of an appropriate persona.

According to an embodiment, in a situation 1002, the electronic device 501 may receive the input (e.g., an utterance) (e.g., “Start my car”) from the user. The electronic device 501, which is not capable of performing vehicle control, may need to provide a rejection response to the input (e.g., “Start my car”). The electronic device 501 may review the appropriateness of the response generated by the generative model, based on a response verification module (e.g., the response verification module 525 of FIG. 6). The electronic device 501 may review the appropriateness of the response and provide the user with a rejection response (e.g., “I cannot perform car-related functions”) corresponding to the input.

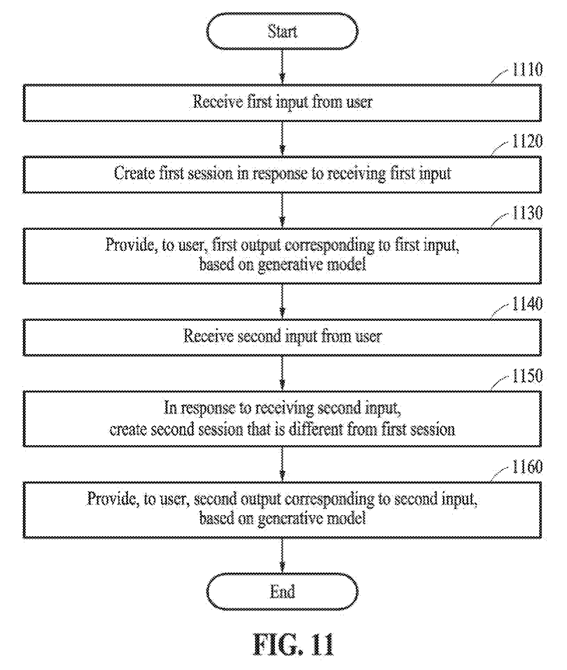

FIG. 11 is a flowchart of an operating method of an electronic device, according to an embodiment.

Operations 1110 to 1160 may be performed sequentially but not necessarily. For example, the order of each of operations 1110 to 1160 may be changed, and at least two operations may be performed in parallel.

According to an embodiment, operations 1110 to 1160 may be understood as being performed by a processor (e.g., the processor 520 of FIG. 6) of an electronic device (e.g., the electronic device 501 of FIG. 6).

In operation 1110, the electronic device (e.g., the electronic device 501 of FIG. 5) according to an embodiment may receive a first input from a user.

In operation 1120, the electronic device according to an embodiment may create a first session in response to receiving the first input.

In operation 1130, the electronic device according to an embodiment may provide, to the user, a first output corresponding to the first input, based on a generative model.

In operation 1140, the electronic device according to an embodiment may receive a second input from the user.

In operation 1150, the electronic device according to an embodiment may create, in response to receiving the second input, a second session that is different from the first session when a condition (e.g., a correlation) between the first input and the second input and a condition (e.g., a correlation) between the first output and the second input are satisfied.

In operation 1160, the electronic device according to an embodiment may provide, to the user, a second output corresponding to the second input, based on the generative model.

An operating method of an electronic device (e.g., the electronic device 101 of FIG. 1, the electronic device 201 of FIG. 2, or the electronic device 501 of FIG. 5), according to an embodiment, may include receiving a first input from a user. The operating method may include creating a first session based on receiving the first input. The operating method may include providing a first output corresponding to the first input, based on a generative model. The operating method may include receiving a second input from the user. The operating method may include creating a second session that is different from the first session based on a condition between the first input and the second input and a condition between the first output and the second input being satisfied. The operating method may include providing a second output corresponding to the second input, based on the generative model.

According to an embodiment, the providing the first output may include configuring first prompt text. The providing the first output may include generating first text data by inputting the first prompt text to the generative model. The providing the first output may include performing a first task corresponding to the first input, based on the first text data. The providing the first output may include providing the first output corresponding to the first task.

According to an embodiment, the providing the second output may include configuring second prompt text. The providing the second output may include generating second text data by inputting the second prompt text to the generative model. The providing the second output may include performing a second task corresponding to the second input, based on the second text data. The providing the second output may include providing, to the user, the second output corresponding to the second task.

According to an embodiment, information used in the first session to configure the first prompt text is different from information used in the second session to configure the second prompt text.

According to an embodiment, each of the first session and the second session may include an input of the user and an output of the electronic device, in which the second session may be created based on both a correlation between the first input and the second input and a correlation between the first output and the second input being less than a threshold value.

According to an embodiment, each of the correlation between the first input and the second input and the correlation between the first output and the second input may be determined based on a similarity between utterances or RLHF.

According to an embodiment, the providing the second output may include providing the second output after reviewing the appropriateness of the second output.

An operating method of an electronic device (e.g., the electronic device 101 of FIG. 1, the electronic device 201 of FIG. 2, or the electronic device 501 of FIG. 5), according to an embodiment, may include receiving a first input from a user. The operating method may include providing a first output corresponding to the first input, based on a generative model. The operating method may include receiving a second input from the user. The operating method may include adaptively configuring prompt text based on at least one of a correlation between the first input and the second input or a correlation between the first output and the second input. The operating method may include providing a second output corresponding to the second input by inputting the prompt text to the generative model.

According to an embodiment, when the correlation between the first input and the second input and the correlation between the first output and the second input are less than a threshold value, the second input may be managed through a different session from the first input. When at least one of the correlation between the first input and the second input or the correlation between the first output and the second input is greater than or equal to the threshold value, the second input may be managed through the same session as the first input.

According to an embodiment, when the second input is managed through the same session as the first input, the prompt text may be configured based on at least one of the first input or the first output.

According to an embodiment, the providing the second output may include generating text data by inputting the prompt text to the generative model. The providing the second output may include performing a task corresponding to the second input based on the text data. The providing the second output may include providing, to the user, the second output corresponding to the task.

According to an embodiment, the at least one may be determined based on a similarity between utterances or RLHF.

According to an embodiment, the providing the second output may include providing the second output after reviewing the appropriateness of the second output.

An electronic device (e.g., the electronic device 101 of FIG. 1, the electronic device 201 of FIG. 2, or the electronic device 501 of FIG. 5), according to an embodiment, may include at least one processor (e.g., the processor 120 of FIG. 1, the processor 203 of FIG. 2, or the processor 520 of FIG. 5). The electronic device may include memory (e.g., the memory 130 of FIG. 1, the memory 207 of FIG. 2, or the memory 530 of FIG. 5) storing instructions. The instructions, when executed by the at least one processor individually or collectively, may cause the electronic device to receive a first input from a user. The instructions, when executed by the at least one processor individually or collectively, may cause the electronic device to create a first session based on receiving the first input. The instructions, when executed by the at least one processor individually or collectively, may cause the electronic device to provide, to the user, a first output corresponding to the first input, based on a generative model. The instructions, when executed by the at least one processor individually or collectively, may cause the electronic device to receive a second input from the user. The instructions, when executed by the at least one processor individually or collectively, may cause the electronic device to create a second session that is different from the first session based on a condition between the first input and the second input and a condition between the first output and the second input being satisfied. The instructions, when executed by the at least one processor individually or collectively, may cause the electronic device to provide a second output corresponding to the second input, based on the generative model.

According to an embodiment, the instructions, when executed by the at least one processor individually or collectively, may cause the electronic device to configure first prompt text. The instructions, when executed by the at least one processor individually or collectively, may cause the electronic device to generate first text data by inputting the first prompt text to the generative model. The instructions, when executed by the at least one processor individually or collectively, may cause the electronic device to perform a first task corresponding to the first input, based on the first text data. The instructions, when executed by the at least one processor individually or collectively, may cause the electronic device to provide the first output corresponding to the first task.

According to an embodiment, the instructions, when executed by the at least one processor individually or collectively, may cause the electronic device to configure second prompt text. The instructions, when executed by the at least one processor individually or collectively, may cause the electronic device to generate second text data by inputting the second prompt text to the generative model. The instructions, when executed by the at least one processor individually or collectively, may cause the electronic device to perform a second task corresponding to the second input, based on the second text data. The instructions, when executed by the at least one processor individually or collectively, may cause the electronic device to provide the second output corresponding to the second task.

According to an embodiment, information used in the first session to configure the first prompt text may be different from information used in the second session to configure the second prompt text.

According to an embodiment, each of the first session and the second session may include an input of the user and an output of the electronic device, in which the second session may be created based on both a correlation between the first input and the second input and a correlation between the first output and the second input being less than a threshold value.

According to an embodiment, each of the correlation between the first input and the second input and the correlation between the first output and the second input may be determined based on a similarity between utterances or RLHF.

According to an embodiment, the instructions, when executed by the at least one processor individually or collectively, cause the electronic device to provide the second output to the user after reviewing the appropriateness of the second output.

According to an aspect of the disclosure, a non-transitory computer-readable storage medium stores one or more programs, the one or more programs comprising instructions which, when executed by a processor of an electronic device, cause the electronic device to: receive a first input from a user; based on receiving the first input, create a first session; provide a first output corresponding to the first input, based on a generative model; receive a second input from the user; based on a condition between the first input and the second input and a condition between the first output and the second input being satisfied, create a second session that is different from the first session; and provide a second output corresponding to the second input, based on the generative model.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. The electronic devices may include, for example, a portable communication device (e.g., a smartphone), a computer device, a portable multimedia device, a portable medical device, a camera, a wearable device, or a home appliance.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

Various embodiments as set forth herein may be implemented as software (e.g., program) including one or more instructions that are stored in a storage medium (e.g., internal memory or external memory) that is readable by a machine (e.g., electronic device). For example, a processor (e.g., a processor) of the machine (e.g., an electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An operating method of an electronic device, the operating method comprising:
receiving a first input from a user;
based on receiving the first input, creating a first session;
providing a first output corresponding to the first input, based on a generative model;
receiving a second input from the user;
based on a condition between the first input and the second input and a condition between the first output and the second input being satisfied, creating a second session that is different from the first session; and
providing a second output corresponding to the second input, based on the generative model.

2. The operating method of claim 1, wherein the providing the first output comprises:
configuring first prompt text;
generating first text data by inputting the first prompt text to the generative model;
performing a first task corresponding to the first input, based on the first text data; and
providing the first output corresponding to the first task.

3. The operating method of claim 2, wherein the providing the second output comprises:
configuring second prompt text;
generating second text data by inputting the second prompt text to the generative model;
performing a second task corresponding to the second input, based on the second text data; and
providing the second output corresponding to the second task.

4. The operating method of claim 3, wherein information used in the first session to configure the first prompt text is different from information used in the second session to configure the second prompt text.

5. The operating method of claim 1, wherein each of the first session and the second session comprises an input of the user and an output of the electronic device, and
wherein the second session is created based on both a correlation between the first input and the second input and a correlation between the first output and the second input being less than a threshold value.

6. The operating method of claim 5, wherein each of the correlation between the first input and the second input and the correlation between the first output and the second input is determined based on a similarity between utterances or reinforcement learning with human feedback.

7. The operating method of claim 1, wherein the providing the second output comprises providing the second output after reviewing appropriateness of the second output.

8. An electronic device comprising:
at least one processor; and
memory storing instructions,
wherein the instructions, when executed by the at least one processor individually or collectively, cause the electronic device to:
receive a first input from a user;
based on receiving the first input, create a first session;
provide a first output corresponding to the first input, based on a generative model;
receive a second input from the user;
based on a condition between the first input and the second input and a condition between the first output and the second input being satisfied, create a second session that is different from the first session; and
provide a second output corresponding to the second input, based on the generative model.

9. The electronic device of claim 8, wherein the instructions, when executed by the at least one processor individually or collectively, cause the electronic device to:
configure first prompt text;
generate first text data by inputting the first prompt text to the generative model;
perform a first task corresponding to the first input, based on the first text data; and
provide the first output corresponding to the first task.

10. The electronic device of claim 9, wherein the instructions, when executed by the at least one processor individually or collectively, cause the electronic device to:
configure second prompt text;
generate second text data by inputting the second prompt text to the generative model;
perform a second task corresponding to the second input, based on the second text data; and
provide the second output corresponding to the second task.

11. The electronic device of claim 10, wherein information used in the first session to configure the first prompt text is different from information used in the second session to configure the second prompt text.

12. The electronic device of claim 8, wherein each of the first session and the second session comprises an input of the user and an output of the electronic device, and
wherein the second session is created based on both a correlation between the first input and the second input and a correlation between the first output and the second input being less than a threshold value.

13. The electronic device of claim 12, wherein each of the correlation between the first input and the second input and the correlation between the first output and the second input is determined based on a similarity between utterances or reinforcement learning with human feedback.

14. The electronic device of claim 8, wherein the instructions, when executed by the at least one processor individually or collectively, cause the electronic device to provide the second output after reviewing appropriateness of the second output.

15. An operating method of an electronic device, the operating method comprising:
receiving a first input from a user;
based on receiving the first input, creating a first session;
providing a first output corresponding to the first input, based on a generative model;
receiving a second input from the user;
adaptively configuring prompt text based on at least one of a correlation between the first input and the second input or a correlation between the first output and the second input; and
providing a second output corresponding to the second input by inputting the prompt text to the generative model.

16. The operating method of claim 15, wherein when the correlation between the first input and the second input and the correlation between the first output and the second input are less than a threshold value, the second input may be managed through a different session from the first input, and
wherein when at least one of the correlation between the first input and the second input or the correlation between the first output and the second input is greater than or equal to the threshold value, the second input may be managed through the same session as the first input.

17. The operating method of claim 16, wherein when the second input is managed through the same session as the first input, the prompt text may be configured based on at least one of the first input or the first output.

18. The operating method of claim 15, wherein the providing the second output comprises:
generating text data by inputting the prompt text to the generative model;
performing a task corresponding to the second input based on the text data; and
providing the second output corresponding to the task.

19. The operating method of claim 15, wherein the at least one is determined based on a similarity between utterances or RLHF.

20. The operating method of claim 15, wherein the providing the second output comprises provide the second output after reviewing the appropriateness of the second output.
